(19) United States
(12) Patent Application Publication
(10) Pub. No.: US 2019/0085598 A1
(43) Pub. Date: Mar. 21, 2019

(54) THIN PADLOCK WITH SIMPLE AND CONVENINENT OPERATION

(71) Applicant: YIFENG MANUFACTURING CO., LTD., DONGGUAN City (CN)

(72) Inventor: Leo LAI, Dongguan City (CN)

(21) Appl. No.: 16/084,938

(22) PCT Filed: Dec. 14, 2017
(86) PCT No.: PCT/CN2017/116054

§ 371 Date: Sep. 13, 2018

(30) Foreign Application Priority Data
Jan. 24, 2017 (CN) 201710054794.3

(51) Int. Cl. E05B 65/52; E05B 37/02; E05B 37/00

(52) U.S. Cl. CPC E05B 65/5215; E05Y 2900/602; E05B 37/0034; E05B 37/02

(57) ABSTRACT

A thin padlock with simple and convenient operation includes a lock hook, a lock buckle and a lock cylinder module capable of locking the padlock. The lock cylinder module is embedded into a box; a small portion of the lock cylinder module is protruded from the outer surface of the box, so that the thickness of the padlock protruding to the outside of the box is reduced, and the padlock will not be damage by external forces easily. In an unlock process, the lock cylinder module slides with respect to the box and drives the lock hook to move and be separated from the lock buckle. The lock cylinder module integrates a pressing unlock function to skip the pressing action, thus not just reducing the thickness of the padlock protruding to the outside of the box only, but also allowing users to operate the lock cylinder module by a finger to unlock the padlock and improve the convenience of operating the padlock.

### FIELD OF INVENTION

The present invention relates to the field of locks, in particular to a thin padlock with simple and convenient operation.

### BACKGROUND OF INVENTION

### 1. Description of the Related Art

In general, a conventional padlock has a relatively larger thickness, and when padlock is installed to the exterior of the box, the padlock will be much higher than the outer surface of the box, so that the padlock may be damaged easily by external forces during the transportation and using processes. To overcome this problem, the box generally comes with a recess for installing the padlock therein to achieve the effect of protecting the padlock. However, such arrangement also increases the complexity of the box.

In the prior art, the padlock is generally locked and/or unlocked by the operation of several fingers or at least two fingers. For example, the padlock disclosed in P.R.C. Pat. No. CN105239855A requires a user to use two fingers to press the padlock for unlock, and thus the operation of the conventional padlock is not convenient or simple at all, and the pressing mechanism further increases the thickness of the padlock protruding to the outside from the box.

### 2. Summary of the Invention

Therefore, it is a primary objective of the present invention to overcome the deficiency of the prior art, the present invention provide a thin padlock with simple and convenient operation, wherein the thickness of the padlock protruding to the outside from the box is reduced, so that the padlock will not be damaged easily by external forces, and the box no longer requires the recess, so as to simplify the manufacturing process of the box.

To achieve the aforementioned and other objectives, the present invention provides a thin padlock with simple and convenient operation,

comprising a lock hook, a lock buckle, and a lock cylinder module capable of locking the padlock, and the lock buckle being fixed to an opening and closing side of a box, characterized in that the lock cylinder module is embedded into another opening and closing side of the box, and during an unlock process of the padlock, the lock cylinder module is capable of sliding in an embedding direction with respect to the box to drive the lock cylinder module to move the lock hook until the lock hook is separated from the lock buckle.

Wherein, the padlock comprises a lock body embedded into the box, and a lock cylinder module built in the lock body and capable of sliding with respect to the lock body.

Wherein, the lock body further includes a connecting block therein, and the lock cylinder module passes through the connecting block to drive the lock hook to move.

Wherein, the lock cylinder module has a sliding rod or an oblique chute, and the connecting block has an oblique chute or a sliding rod, and the sliding rod is disposed in the oblique chute and capable of sliding along the oblique chute, so that the lock cylinder module drives the connecting block to move.

Wherein, the connecting block has a latch slot, and the lock hook has a latch bump provided for being latched to the latch slot.

Wherein, the lock hook further has a lock column, and the lock buckle has a keyhole provided for being locked with the lock column, and the lock cylinder module drives the lock hook to move, so as to separate the lock column from the keyhole.

Wherein, the padlock further comprises a lock block, and the lock block has a locking projection, and when the padlock is situated at a locked state, the locking projection abuts the lock cylinder module, so that the lock cylinder module cannot slide or move; and when the padlock is situated at an unlock state, the locking projection and the lock cylinder module are misaligned with each other, so that the lock cylinder module can slide or move.

Wherein, the lock cylinder module comprises a lock cylinder and a clutch operated with the lock cylinder, and the clutch has an unlock bump, and when the padlock is situated at a locked state, the locking projection abuts the unlock bump, so that the lock cylinder module cannot slide or move; and when the padlock is in a combination unlock process, the lock cylinder drives the unlock bump to rotate to a position misaligned with the locking projection, so that the lock cylinder module can slide or move.

Wherein, the padlock further comprises a combination device capable of locking the padlock, and when the padlock is situated at a locked state, the combination device abuts the lock block, so that the locking projection abuts the lock cylinder module; and when the padlock is in a combination unlock process, the combination device releases the abutment of the lock block, so that the lock block is capable of moving to the locking projection is misaligned with the lock cylinder module.

Wherein, the thin padlock with simple and convenient operation further comprises a lock cover hinged with the lock body, and the lock hook being built in the lock cover and slidably coupled to the lock cover, so that the lock cylinder module is capable of driving the lock hook to move.

The present invention has the following advantageous effects:

In the thin padlock of the present invention, the lock cylinder module is embedded into the box, so that just a portion of the lock cylinder module is protruded from the outer surface of the box, and the thinness of the padlock protruded out from the box is smaller, and the padlock will not be damaged by external forces easily. During an unlock process of the padlock, the lock cylinder module is capable of sliding along the embedding direction with respect to the box, so as to drive the lock hook to move until the lock hook is separated from the lock buckle. Therefore, the lock cylinder module integrates the unlock function of the prior art to skip the pressing mechanism, and such arrangement not just further makes the thickness of the padlock protruding to the outside from the box smaller only, but also allows users to operate the lock cylinder module by a single finger to unlock the padlock, so as to improve the convenience of operating the padlock.

### BRIEF DESCRIPTION OF THE DRAWINGS

FIG. 1 is a first schematic view of a combination lock installed onto a box in accordance with the present invention;

FIG. 2 is a cross-sectional view of a combination lock of the present invention situated at a locked state;

FIG. 3 is a cross-sectional view of a combination lock of the present invention situated at an unlocked state;

FIG. 4 is a schematic view of a lock cylinder module, a connecting block, a lock block, and a combination device of a combination lock in accordance with the present invention; and

FIG. 5 is an exploded view of a combination lock in accordance with the present invention.

### DESCRIPTION OF THE PREFERRED EMBODIMENTS

To make it easier for our examiner to understand the objective, technical characteristics, structure, innovative features, and performance of the invention, we use preferred embodiments together with the attached drawings for the detailed description of the invention.

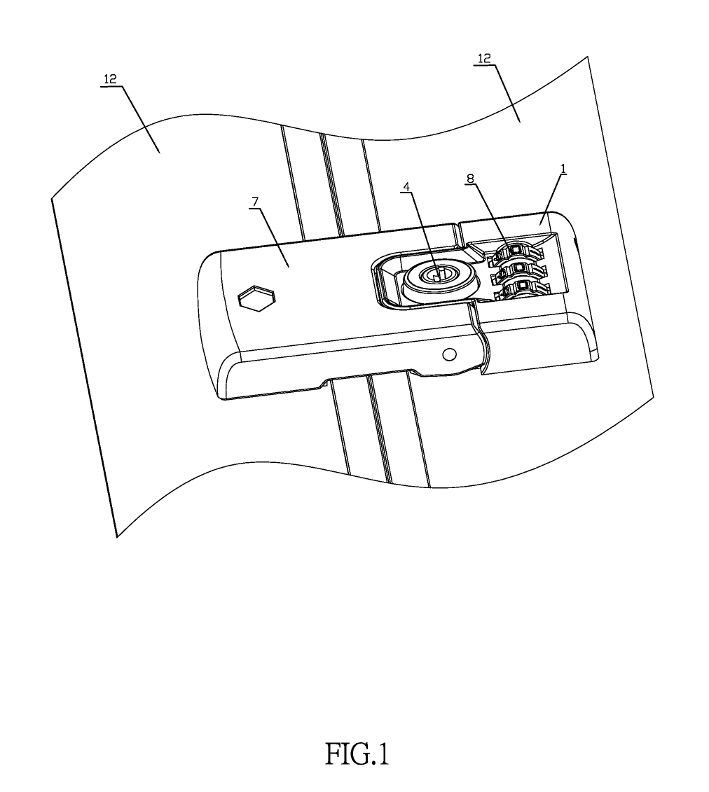

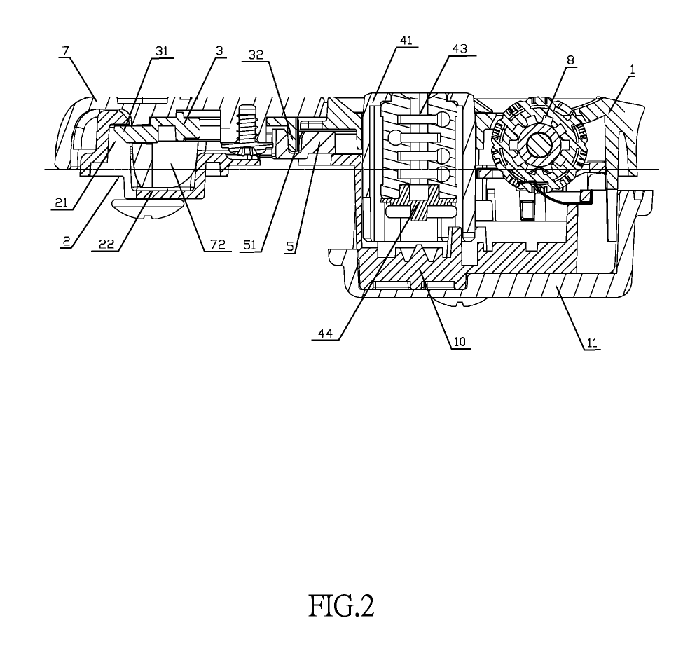

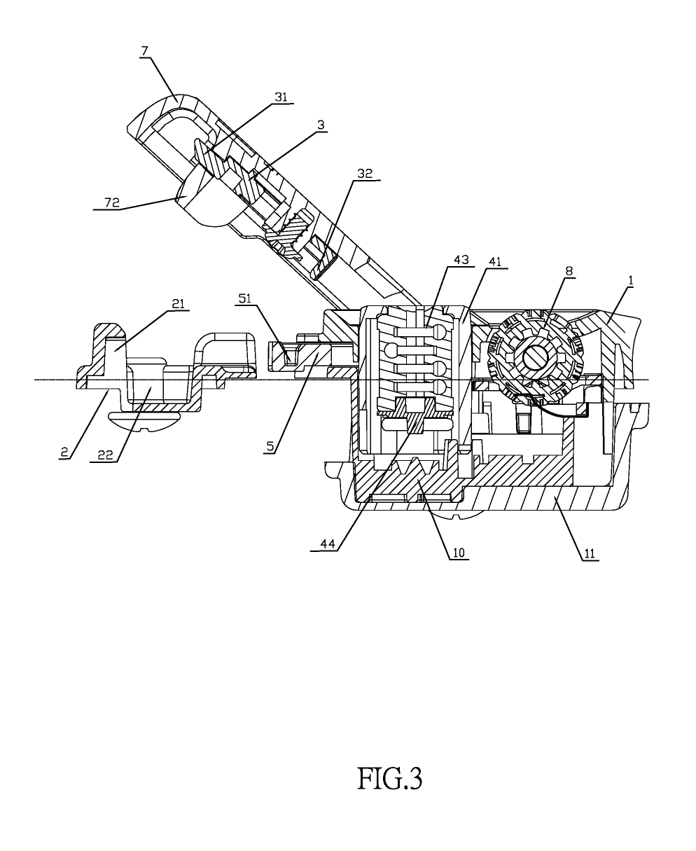

With reference to FIGS. 1 and 2 for a thin padlock with simple and convenient operation in accordance with an embodiment of the present invention, the thin padlock comprises a lock buckle 2 and a lock body 1, wherein the lock buckle 2 is fixed to an opening and closing side of a box 12, and the lock buckle 2 has a lock cover 7 covered thereon, and the lock cover 7 is hinged with the lock body 1, and the lock body 1 is embedded into another opening and closing side of the box 12 (wherein the portion under the dotted line as shown in FIGS. 2 and 3 is embedded into the box), so that only a small portion of the lock body 1 is protruded from the box 12, and the lock body 1 has a lock cylinder module 4 and a combination device 8 built therein. During the unlock process of the padlock (including the combination unlock and the key unlock), the lock cylinder module 4 can slide in a direction perpendicular to the embedding direction of the box 12, and a user's finger presses the lock cylinder module 4 to drive the lock hook 3 to move to the right until the lock buckle 2 is separated (as shown in FIG. 3) to achieve the unlock effect of the padlock. Since the lock body 1 has only a small part protruding to the outside from the box 12, the thickness of the padlock protruding to the outside of the box 12 is reduced to prevent the padlock from being damaged by external forces easily. Wherein, the lock cylinder module 4 integrates the unlock function achieved by a pushing mechanism of the prior art, so that the padlock of the present invention skips the pushing mechanism for the transversal motion and further reduces the thickness of the padlock protruding to the outside from the box 12 and allows users to operate the lock cylinder module 4 by a single finger for the unlock, so as to make the operation of the padlock simpler and more convenient.

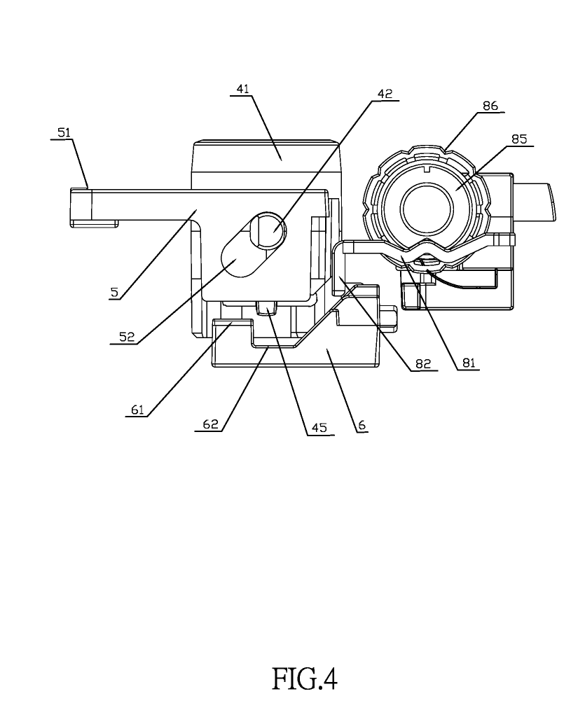

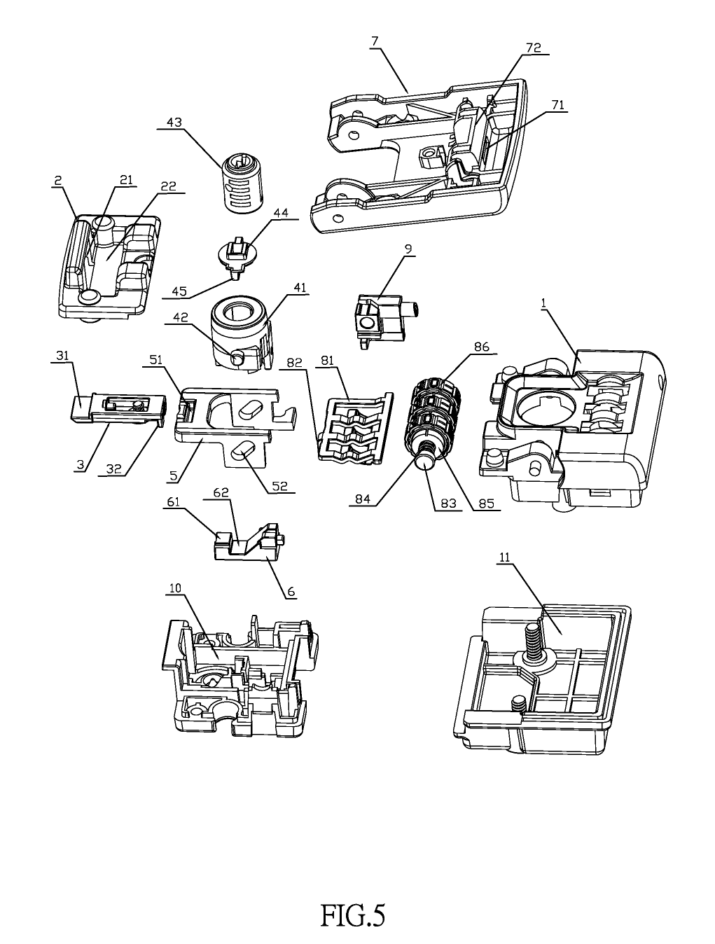

In FIGS. 2 to 5, the lock cover 7 has an installation hole 71 (wherein FIG. 5 shows the internal structure of the lock cover), and the lock hook 3 is slidably installed into the installation hole 71, and the lock hook 3 is rotated with the lock cover 7, and the lock hook 3 has a lock column 31 at the left end of the lock hook 3 and a latch bump 32 at the right end of the lock hook 3, and the lock buckle 2 has a keyhole 21 for locking the lock column 31, and the lock body 1 further has a connecting block 5 built therein, and the connecting block 5 has a latch slot 51 latched with the latch bump 32, and the connecting block 5 further has an oblique chute 52, and the lock cylinder module 4 includes a lock cylinder sleeve 41 and a lock cylinder 43, and the lock cylinder 43 is built in the lock cylinder sleeve 41 and capable of rotating therein, and the lock cylinder sleeve 41 has a sliding rod 42 disposed on an outer wall of the lock cylinder sleeve 41 and the sliding rod 42 is disposed in the oblique chute 52 and capable of sliding along the oblique chute 52 (as shown in FIG. 4). In an unlock process, the lock cylinder module 4 is pressed, and the sliding rod 42 slides in the oblique chute 52 to pull the connecting block 5 to move to the right and also pull the lock hook 3 to move to the right, so that the lock column 31 is separated from the keyhole 21. Since a bouncing spring is installed between the lock cover 7 and the lock body 1, the lock cover 7 flips upward automatically by the action of the bouncing spring (as shown in FIG. 3). In addition, the lock hook 3 is rotated with the lock cover 7, and the latch bump 32 is separated from the latch slot 51, so that the box 12 can be opened.

A lock hook spring (not shown in the figure) is installed between the lock hook 3 and the lock cover 7 for automatically restoring the lock hook 3 into its original position, so that when it is necessary to lock the padlock, the lock cover 7 is pressed, so that the lock cover 7 is rotated downwardly. Before the lock column 31 and the keyhole 21 are latched with each other, the lock column 31 is abutted by a stop portion at the top of the keyhole 21 to move to the right, so as to compress the lock hook spring. After the lock column 31 passes through the stop portion, the lock hook spring pushes the lock hook 3 to restore its original position, so that the lock column 31 can be latched into the keyhole 21, while the latch bump 32 is being latched into the latch slot 51 (as shown in FIG. 2).

In FIG. 3, the lock cover 7 further has a guide column 72, and the lock buckle 2 has a guide slot 22 configured to be corresponsive to the guide column 72. Before the lock cover 7 is pressed to latch the lock column 31 into the keyhole 21, the guide column 72 is plugged into the guide slot 22, so that the lock column 31 can be plugged into the keyhole 21 successfully.

In FIGS. 4 and 5, the padlock further comprises a lock block 6 built in the lock body 1, and the lock block 6 has a locking projection 61, and the lock cylinder module 4 further comprises a clutch 44 built in the lock cylinder sleeve 41 and disposed at the bottom of the clutch 44 and rotated with the lock cylinder 43, and the clutch 44 has an unlock bump 45. When the padlock is situated at a locked state, the locking projection 61 abuts the unlock bump 45 to prevent the whole lock cylinder module 4 from moving downward, so that the lock column 31 will not be driven or separated from the keyhole 21. In a key unlock process, a key drives the lock cylinder 43 to rotate, so as to drive the clutch 44 to rotate. The unlock bump 45 is rotated to a position misaligned with the locking projection 61, so that the lock cylinder module 4 can be pressed down to achieve the effect of unlocking the padlock.

The padlock further comprises a combination device 8 built in the lock body 1, and the combination device 8 comprises a locking plate 81, a combination wheel 86, a combination adjusting wheel 85, a combination adjusting spring 84, and an axle 83, combination adjusting spring 84, and the combination adjusting wheel 85 and the combination wheel 86 is sheathed on the axle 83 sequentially from the inside to the outside, and the locking plate 81 is disposed under the combination adjusting wheel 85. If the combination wheel 86 is set with a wrong combination lock, the combination adjusting wheel 85 presses the locking plate 81 downwardly, so that the lock tongue 82 of the locking plate 81 is moved downwardly to push the lock block 6 to move to the right, and the locking projection 61 abuts the unlock bump 45 to prevent the whole lock cylinder module 4 from moving downward. In a combination unlock process, the combination wheel 86 is dialed to a correct combination, and the combination adjusting wheel 85 releases the downward abutment of the locking plate 81, so that the locking plate 81 is moved upward by the downward push of the restoring spring. In the meantime, the lock block 6 is moved to the left by the push of the restoring spring, so that an unlock recession 62 of the lock block 6 is moved and aligned precisely with the unlock bump 45 (as shown in FIG. 4), and the lock cylinder module 4 can be pressed down.

The padlock further comprises a combination adjusting device 9, wherein when the padlock is situated at an unlock state, the combination adjusting device 9 may be pressed to reset the combination. After the combination is reset, the combination adjusting device 9 may be released, so that the combination adjusting device 9 resumes its original position automatically by the push of the combination adjusting spring 84 to complete the whole combination adjusting process.

In an embodiment as shown in FIGS. 2, 3, and 5, a base plate 10 is installed at the bottom of the lock body 1 to support the components in the lock body 1 and facilitate the installation of the components into the lock body 1, and a lock cylinder module 4 is installed between the base plate 10 and the clutch 44 for pushing and resetting a lock cylinder module spring (not shown in the figure), and manually pressing the lock cylinder module 4 downward to compress the lock cylinder module spring. After the manual release, the lock cylinder module spring will push the lock cylinder module 4 to move upward for the reset.

To enhance the structure of the lock body 1, the bottom of the base plate 10 has a lower casing 11 fixed to the lock body 1.

While the invention has been described by means of specific embodiments, numerous modifications and variations could be made thereto by those skilled in the art without departing from the scope and spirit of the invention set forth in the claims.

What is claimed is:

1. A thin padlock with simple and convenient operation, comprising a lock hook, a lock buckle, and a lock cylinder module capable of locking the padlock, and the lock buckle being fixed to an opening and closing side of a box, characterized in that the lock cylinder module is embedded into another opening and closing side of the box, and during an unlock process of the padlock, the lock cylinder module is capable of sliding in an embedding direction with respect to the box to drive the lock cylinder module to move the lock hook until the lock hook is separated from the lock buckle.

2. The thin padlock with simple and convenient operation according to claim 1, wherein the padlock comprises a lock body embedded into the box, and a lock cylinder module built in the lock body and capable of sliding with respect to the lock body.

3. The thin padlock with simple and convenient operation according to claim 2, wherein the lock body further includes a connecting block therein, and the lock cylinder module passing through the connecting block to drive the lock hook to move.

4. The thin padlock with simple and convenient operation according to claim 3, wherein the lock cylinder module has a sliding rod or an oblique chute, and the connecting block has an oblique chute or a sliding rod, and the sliding rod is built in the oblique chute and capable of sliding along the oblique chute, so that the lock cylinder module drives the connecting block to move.

5. The thin padlock with simple and convenient operation according to claim 3, wherein the connecting block has a latch slot, and the lock hook has a latch bump provided for being latched to the latch slot.

6. The thin padlock with simple and convenient operation according to claim 1, wherein the lock hook further has a lock column, and the lock buckle has a keyhole provided for being locked with the lock column, and the lock cylinder module drives the lock hook to move, so as to separate the lock column from the keyhole.

7. The thin padlock with simple and convenient operation according to claim 1, wherein the padlock further comprises a lock block, and the lock block has a locking projection, and when the padlock is situated at a locked state, the locking projection abuts the lock cylinder module, so that the lock cylinder module cannot slide or move; and when the padlock is situated at an unlock state, the locking projection and the lock cylinder module are misaligned with each other, so that the lock cylinder module can slide or move.

8. The thin padlock with simple and convenient operation according to claim 7, wherein the lock cylinder module comprises a lock cylinder and a clutch operated with the lock cylinder, and the clutch has an unlock bump, and when the padlock is situated at a locked state, the locking projection abuts the unlock bump, so that the lock cylinder module cannot slide or move; and when the padlock is in a combination unlock process, the lock cylinder drives the unlock bump to rotate to a position misaligned with the locking projection, so that the lock cylinder module can slide or move.

9. The thin padlock with simple and convenient operation according to claim 7, wherein the padlock further comprises a combination device capable of locking the padlock, and when the padlock is situated at a locked state, the combination device abuts the lock block, so that the locking projection abuts the lock cylinder module; and when the padlock is in a combination unlock process, the combination device releases the abutment of the lock block, so that the lock block is capable of moving to the locking projection is misaligned with the lock cylinder module.

10. The thin padlock with simple and convenient operation according to claim 1, further comprising a lock cover hinged with the lock body, and the lock hook being built in the lock cover and slidably coupled to the lock cover, so that the lock cylinder module is capable of driving the lock hook to move.
